(19) United States
(12) Patent Application Publication
(10) Pub. No.: US 2012/0173795 A1
(43) Pub. Date: Jul. 5, 2012

(54) SOLID STATE DRIVE WITH LOW WRITE AMPLIFICATION

(75) Inventors: Franz Michael Schuette, Colorado Springs, CO (US); Anthony Leach, Cheshire (GB)

(73) Assignee: OCZ TECHNOLOGY GROUP, INC., San Jose, CA (US)

(21) Appl. No.: 13/115,716

(22) Filed: May 25, 2011

Related U.S. Application Data
(60) Provisional application No. 61/348,009, filed on May 25, 2010.

(51) Int. Cl. G06F 12/00

(52) U.S. Cl. 711/103; 711/E12.008

(57) ABSTRACT

A solid state drive having a non-volatile memory device and methods of operating the solid state drive to compare existing data stored on the memory device to subsequent data in an incoming data stream received by the solid state drive from a host system. If matching data are found, the solid state drive uses the existing data instead of writing the subsequent data to the memory device. Common data patterns can be shared among different files stored on the memory device.

### CROSS REFERENCE TO RELATED APPLICATIONS

This application claims the benefit of U.S. Provisional Application Nos. 61/348,009 filed May 25, 2010. The contents of this prior application are incorporated herein by reference.

### BACKGROUND OF THE INVENTION

The present invention generally relates to nonvolatile solid-state memory devices. More particularly, this invention relates to improving the utilization of properties of a solid state drive comprising at least one nonvolatile solid-state memory device by writing less data to the memory device than are transferred from a host system to the solid state drive.

As known in the art, flash memory is a type of nonvolatile solid-state memory technology. Flash memory components store information in an array of floating-gate transistors (FGTs), referred to as cells. NAND flash cells are organized in what are commonly referred to as pages, which in turn are organized in predetermined sections of the component referred to as memory blocks. Each cell of a NAND flash memory component has a top or control gate (CG) and a floating gate (FG), the latter being sandwiched between the control gate and the channel of the cell. The floating gate is separated from the control gate by an oxide layer and from the channel by another oxide layer, referred to as the tunnel oxide. Data are stored in a NAND flash cell in the form of a charge on the floating gate which, in turn, defines the channel properties of the NAND flash cell by either augmenting or opposing the charge of the control gate. The process of programming (writing 0's to) a NAND cell requires applying a programming charge to the floating gate by applying a programming voltage to the control gate via the word lines. The control gate exerts a Fowler-Nordheim (FN) field that causes the injection of electrons into the floating gate by quantum mechanical tunneling, that is, drawing electrons from the substrate towards the positive charge present in the word line until they reach the floating gate. The process of erasing (writing 1's to) a NAND cell requires removing the programming charge from the floating gate by applying an erase voltage to the device substrate via the bit line. The substrate exerts a Fowler-Nordheim field that pulls electrons from the floating gate to deplete the floating gate of any program charge. Data are stored and retrieved on a page-by-page basis and erased on a block-by-block basis.

In many ways, solid state drives are an evolutionary development of rotatable media hard disk drives (HDD), and as such the principle of usage of the NAND flash-based non-volatile memory devices is similar to that of rotatable platters without taking into account the differences between the media. The ignorance of the media results in underutilization of the capabilities of NAND flash memory devices and inadequate use of its advantages, specifically leading to a phenomenon called high write amplification in solid state drives. Compared to the number of bits written by the host to the drive, a substantially higher number of bits is written by the controller to the media. High write amplification results in low write performance as well as decreased endurance and data retention caused by increased program/erase (P/E) cycles in conjunction with proximity effects such as read and write disturbance.

The change in charge distribution of the floating gate augments or counteracts any voltage applied to the control gate. The potential needed to turn “ON” the gate is subsequently used as the bit value of the cell sensed at any given read. Even though, in NAND flash memory, cells need to be programmed sequentially, that is, all cells within a given daisy chain of FGTs (typically thirty-two) must be programmed sequentially, programming and subsequent verification occurs on a per bit level. The application of a programming voltage by the word lines can only inject electrons into the floating gate. Therefore, the direction of programming can only go from a fully erased state to a fully programmed state, but not vice versa.

In order to erase NAND memory cells, the entire bit line needs to be connected to a 20V erase voltage, which causes current to flow through the entire daisy chain of FGTs and induce Fowler-Nordheim quantum mechanical tunneling between the entire bit line comprising the source and drain of all daisy-chained FGTs and the floating gates of the same FGTs, thereby inducing electron depletion of the floating gates.

As noted above, the fully-erased state of a NAND flash memory cell is a “1.” Programming can only shift cells to a lower value. In the case of multilevel cell (MLC) flash memory that uses, for example, four different levels to encode two bits per cell, possible values are “11” (fully erased), “10,” “01” and “00” (fully programmed). However, as mentioned above, programming in the opposite direction is not possible.

Because of the unidirectional programming of flash memory, it is not possible to overwrite data, in contrast to rotatable media hard disk drives (HDDs) or other volatile and non-volatile memory devices. Instead, the media must be fully erased before it can be reprogrammed. From an operational standpoint of a mass storage device, this limitation poses certain difficulties in that data cannot be updated, but instead must be completely rewritten. Because of the specific architecture of NAND flash and also in order to avoid erase latency, the rewriting of data entails writing the updated data to a previously erased block of NAND flash memory, which is typically a different physical block address than the original block. The block containing the previous data is flagged as invalid, which for all practical purposes is equivalent to no longer having data to the file system. However, this block cannot be rewritten until it is completely erased. Over time, such a rewrite routine will result in the majority of blocks being used, but containing invalid data. The term “used” is employed in this context to designate blocks containing invalid data, as opposed to “occupied” blocks that contain valid data. Used blocks require an erase cycle before new data can be written to them. As a result, the drive's write performance slows down significantly.

When new, SSDs exhibit very fast Read and Write speeds because “fresh” (empty) blocks are available and can be programmed immediately. However, as the drive undergoes usage of all available fresh blocks, the blocks fill up with data. Because of wear leveling, subsequent writes will program fresh blocks as long as they are available, even if the data overwrite existing files. In other words, any update consumes a fresh set of blocks (or pages within a block) until there are no more fresh blocks or pages available because all have entered the “used” state. At that point in time, the write performance of any SSD will dramatically slow down because of the required pre-erase routine before new data can be written to the block.

A known workaround for the used vs. occupied block issue is the implementation of garbage collection and TRIM commands, which are tools for consolidating valid data and then proactively erasing blocks with obsolete data. In this context, it is important to note that as many blocks as possible have to be in the “erased state” in order to allow fast write access. In short, garbage collection may result in the contents of a drive being read into main memory, followed by analysis of valid vs. invalid data, subsequent write-back of the valid data to the drive, and purging of invalid data followed by a TRIM command to proactively erase the invalid blocks. Because of wear leveling, the data are typically written to different physical blocks of NAND flash memory. All blocks, the contents of which are read into memory, are erased or scheduled for erase when the data are written back. The net goal of the TRIM operation is that all data contained in any block are valid and used blocks containing invalid data are proactively recycled into the pool of erased, that is, immediately programmable blocks. Moreover, garbage collection in combination with TRIM offers to coalesce data fragments before they are written back to the non-volatile memory in a pattern to maximize occupancy of the blocks.

An additional drawback of an execution of the TRIM function is that it may tie up substantial amounts of system resources with respect to interconnects as well as available system memory space. Therefore, TRIM command executions need to run in the background during idle phases of the system. Still, all of these drawbacks are negligible in view of the write performance maintenance of solid state drives. However, alternative methods could also be employed in order to proactively erase used but not-occupied blocks and, thus, maintain write performance of a solid state drive.

Probably the biggest drawback of electromechanical hard disk drives is their access latency. As long as data are written or read sequentially, meaning with a high locality, conventional HDDs are still very competitive. However, the majority of accesses is random or multithreaded, causing disruption even of existing localities because of fairness algorithms counteracting data starvation of transfer initiators. In the case of true random access patterns, seek and rotational latencies average in the double digit millisecond range except for ultra high-end SCSI drives. This is where the ultra-low access times of NAND flash makes a huge difference. Regardless of the locality of the data, the typical access time is largely independent of the spatial location of the actual bits within the array. In so far, completely random access patterns are not much different with respect to performance from sequential accesses as long as the internal channels can be fully utilized.

The three main differences between DRAM and flash memory devices are that DRAM memory is volatile, DRAM memory allows data to be immediately overwritten, and DRAM memory has practically unlimited write endurance compared to flash memory, whereas flash memory is non-volatile (retains data) but has a very limited write endurance and cannot be overwritten without an erase cycle. Because data are lost every time a DRAM device is powered down, and also because of the unlimited write endurance of DRAM devices, there has been practically no incentive other than conserving bandwidth to “update” or re-use data structures within DRAM devices. Instead all data are immediately overwritten. The situation is quite different in the case of flash memory because of the aforementioned limitations.

In view of the above, though NAND flash memory-based solid state drives are becoming the storage media of choice for personal computers, particular properties of NAND flash memory devices are poorly utilized in current SSDs, leading to high write amplification.

### BRIEF SUMMARY OF THE INVENTION

The present invention provides a solid state drive containing at least one nonvolatile solid-state memory device, and methods of operating a solid state drive to utilize the indifference to physical data distribution within nonvolatile solid-state memory devices to optimize store (or write) access patterns beyond currently used schemes, and in so doing counteracts inherent limitations of nonvolatile solid-state memory technologies. More particularly, the invention seeks to achieve lower write amplifications, including write amplifications lower than 1, by writing less data to the memory devices than are transferred from the host to the solid state drive containing the memory devices. Consequently, not all data transferred from the host to the drive require programming of memory cells of the memory devices in order to store the data.

According to a first aspect of the invention, a solid state drive is provided that is adapted for use with a host system. The solid state drive includes at least one non-volatile memory device comprising pages that are organized into memory blocks. The pages are sequentially programmable and readable, and the memory blocks are minimum-erasable units of the memory device. The drive further includes a controller configured to perform direct data comparison between stored data of existing files stored within the non-volatile memory device and subsequent data of an incoming data stream being written by the host system to the solid state drive.

According to a second aspect of the invention, a method is provided for operating a solid state drive connected to a host system so as to receive an incoming data stream containing data written by the host system to the solid state drive. The solid state drive includes a controller and at least one non-volatile memory device comprising pages that are organized into memory blocks. The pages are sequentially programmable and readable, and the memory blocks are minimum-erasable units of the memory device. The method includes storing data of the incoming data stream on the non-volatile memory device to define stored data of existing files within the memory blocks of the non-volatile memory device, wherein at least some of the existing files define valid files that are within some of the memory blocks that contain valid data. The controller is operated to perform direct data comparison between the stored data of the existing files and subsequent data of the incoming data stream.

According to another aspect of the invention, a method is provided for reducing writes from a host system to a solid state drive that is connected to the host system so as to receive an incoming data stream containing data. The solid state drive includes a controller and at least one non-volatile memory device comprising pages that are organized into memory blocks. The pages are sequentially programmable and readable, and the memory blocks are minimum-erasable units of the memory device. The method includes comparing the data of the incoming data stream to existing data stored within memory blocks of the non-volatile memory device, writing the data of the incoming data stream to the non-volatile memory device if no match is found between the data of the incoming data stream and the existing data, and discarding the data of the incoming data stream if a matching data pattern is found between the data of the incoming data stream and the existing data.

Other aspects and advantages of this invention will be better appreciated from the following detailed description.

### BRIEF DESCRIPTION OF THE DRAWINGS

FIGS. 1 and 2 contain flow diagrams representing data write operations performed by a host system on one or more nonvolatile solid-state memory devices of a solid state drive in accordance with embodiments of the invention.

FIGS. 3 and 4 represent, respectively, a conventional technique of updating files after modification by overwriting an entire file, and the same workflow wherein only changed pages are rewritten in accordance with an embodiment of the invention.

### DETAILED DESCRIPTION OF THE INVENTION

The present invention is generally applicable to computers and other processing apparatuses, and particularly to personal computers, workstations and other apparatuses capable of utilizing nonvolatile (permanent) memory-based mass storage devices. The invention is particularly applicable to solid-state drives (SSDs) that make use of nonvolatile solid-state memory devices, a notable example being NAND flash memory devices. Such SSDs may be configured as internal mass storage devices for a host system equipped with a data and control bus for interfacing with the SSDs. As previously described, NAND flash memory devices store information in an array of FGTs or cells that are organized in pages, which in turn are organized in memory blocks, and the memory blocks constitute minimum-erasable units of the memory device whereas their pages are sequentially programmable and readable.

For the purpose of disambiguation, the following terminology will be used herein with the indicated meanings.

Host system: Computers and other processing apparatuses capable of using a solid-state drive to store data.

Sector: smallest amount of data linked to a logical block address. A sector can be a full page of NAND flash memory or a part thereof.

Valid sectors: Sectors or pages containing useful data that are stored in a memory device and should be saved and not erased. Physical addresses of blocks/pages containing valid data are associated with pointers to virtual addresses on the file system level through a flash translation layer (FTL) in a memory controller of the solid-state drive.

Invalid sectors/pages: Sectors or pages containing data that are stored in a memory device, but are recognized by the host system as garbage. Physical addresses of sectors/pages containing invalid data are no longer associated with pointers to virtual addresses through the flash translation layer in the memory controller or else flagged as invalid on the file system level.

Fresh (empty) block/page: A block/page of a NAND flash memory device that does not contain any data, either because it has not yet been programmed or because it has been erased.

Erased block/page: A block/page of a NAND flash memory device that appears to the drive's memory controller as an empty block/page as a result of the block/page having been erased and not subsequently programmed.

Used block/page: A block/page of a NAND flash memory device that has been programmed and contains data, but appears to a host system as an empty block/page because it contains invalid data. Cells within the block/page retain programmed values and cannot be further programmed without first undergoing an erase cycle.

Occupied block/page: A block/page of a NAND flash memory device that has been programmed and contains valid data. The physical addresses of an occupied block/page are associated with pointers to virtual addresses through the flash translation layer in the memory controller.

In conventional hard disk drives or host system memory, every store of data means that the data are written to the memory storage media. In either technology, the data can be written directly without “priming” the storage media, which, especially in the case of hard disk drives, often means that the data are overwritten. In the case of most solid state drives, the same principle of writing all data to the drive is applied. However, in the case of solid-state memory devices, especially NAND flash memory devices used as memory storage media, this method raises several concerns with respect to endurance and further, it is not possible to write directly to blocks of a NAND flash memory device that are not fresh (empty) or erased blocks, as defined above.

Such a scenario is addressed by the present invention, which seeks to streamline the store (or write process) performed on solid-state memory devices, and particularly NAND flash memory devices. A typical situation in this context is the updating of files. If a file is updated on a conventional hard disk drive, the file is, space permitting, overwritten on the drive using the same logical block addresses that are typically then translated into the same physical block addresses. In the case of a random access system memory device, the physical store location of data does not matter. In fact, the memory controller of the solid state drive will in most cases simply write to the page that it is either open and on which the column address strobe is parked. As a result, the write latency of SDRAM devices has been shorter than their read (CAS) latency.

In the case of NAND flash memory devices, the media constitute a hybrid between random and sequential access. Blocks are selected on a random access basis. The same is true for pages within the blocks, though the pages themselves have to be written and read in sequential fashion. Still, the block address can be selected randomly since no mechanical access latencies are encountered as in the case of rotatable media HDDs. As a result, there is no advantage for the controller to over-write data using the same NAND flash memory cells. Instead, with every update, data are constantly moved to new locations. This also helps with wear leveling, meaning that data are written into new physical locations instead of repeated overwriting of data, which would result in increased program/erase cycles for individual blocks while other blocks within the array would remain at low usage levels. However, every time the host system sends data to the drive, the entire data set is still written to the array. With respect to the physical bit programming levels in cells or logically coherent units of cells, this leads to duplicates of the same data patterns on a sector or page basis which correspond to a logical block address on the level of the file system. However, only the most recent copy of data is valid, whereas the previous copy is stripped of its pointer and thus becomes invalid data.

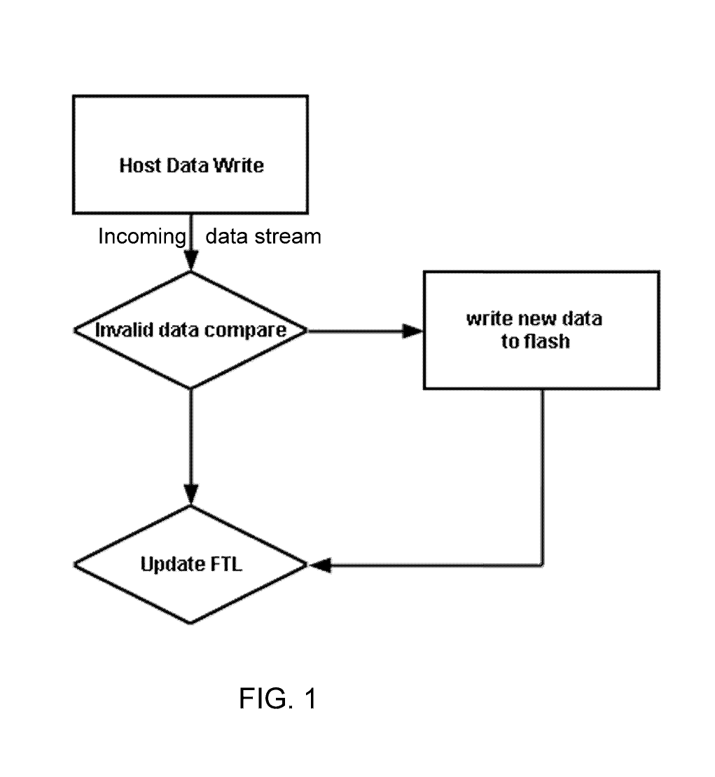

The present invention discloses a technique for reducing writes to one or more solid-state memory devices, and particularly NAND flash memory devices, of a solid state drive by maintaining within the memory controller of the drive an inventory of the data structures present in the non-volatile memory of the memory device. As represented in FIG. 1, during a data write from a host system to a NAND flash-based solid state drive (not shown), the incoming data stream is compared against existing data structures in used sectors of a flash memory device that are no longer valid (invalid data). The data comparison operation is performed by the memory controller of the solid state drive. If no data pattern match is found in the existing, already programmed sectors, the data are written to the flash memory device as in any standard write process. On the other hand, if the memory controller finds a data pattern match in the preexisting programming of sectors as a result of a byte pattern in the incoming data matching a page of invalid data, the incoming data are not written. Instead, the flash translation layer (FTL) is updated to supply the pre-existing physical address as a logical address to the host system. As a result, pointers are updated to reactivate the invalid data and integrate them into the structure of a new file. If an existing file is modified and then saved, then only the modified portions of the file are re-written, whereas parts of the file that are unchanged are not updated. The pointers will then reflect the location of the already pre-existing data fragment as a valid part of the newly-written file.

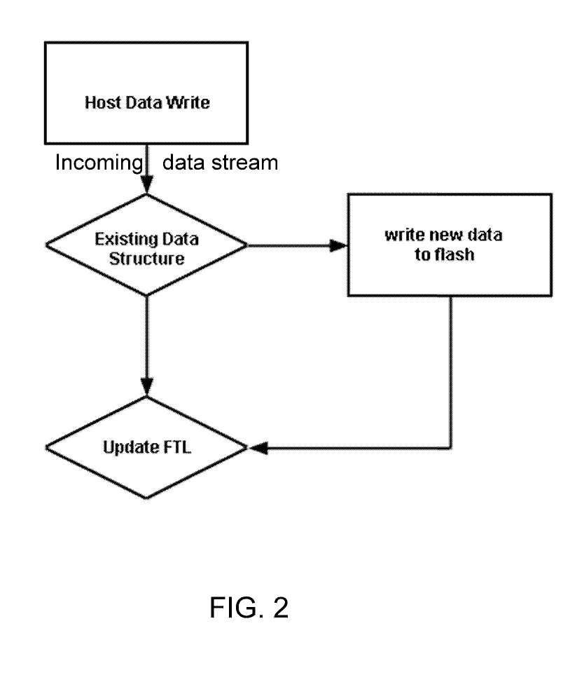

FIG. 2 contains a flow diagram representing a similar process to FIG. 1, but represents a data write operation performed on a solid state drive that checks existing data or files for matching patterns for any sector and then links additional logical addresses that could have repetitive data within the same file or else from different files to the same physical sector.

According to a preferred aspect of the invention, the memory controller of the solid state drive understands that overwriting of a given file will result in a substantial amount of redundancy or duplicates of data. In the easiest case, the controller will compare the incoming data stream to a read-out of the stored data of the original file and, as long as there is a match, it will acknowledge the data as being written without physically storing the data in the location already containing a copy. As soon as there is a discrepancy in the data, the controller will select a new location for the subsequent store of the updated version and mark the respective page of the original file location as invalid. Subsequently, the next page of data from the original file location is read for comparison with the updated file data. If the data structure matches, no store is executed until the next discrepancy in the data pattern is found by the controller.

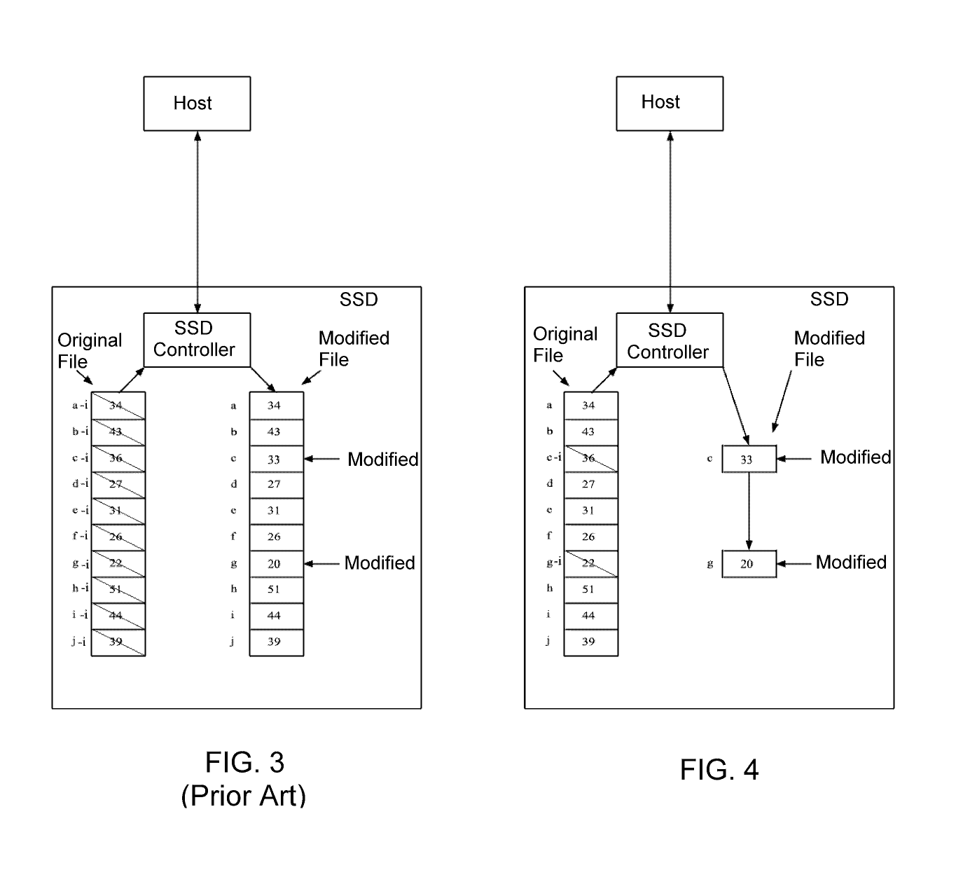

FIG. 3 represents a conventional technique of updating files after modification by overwriting the entire file, whereas FIG. 4 represents the same workflow wherein only changed pages are rewritten in accordance with an embodiment of the invention. In each of FIGS. 3 and 4, a file (“original file”) comprising data in ten pages (a-j) is stored on a solid state drive. The file is read by a host system, then modified and saved onto the drive as a “modified file.” In a standard drive (FIG. 3), the entire file (pages a-j) is rewritten to the drive, even though certain pages (a, b, d, e, f, h, l and j) of the modified file remain the same as the original file. In the case of an SSD, because of the required pre-erase operation, as well as wear-leveling concerns, the pages would be stored in a different physical location and the original pages (a-j) are flagged as invalid (a-i through j-i). As a result, though only pages c and g were modified, the entire file has been stored as a whole in a new location on the drive. According to the invention as represented in FIG. 4, the same operation on the same original file involves writing only the modified pages c and g, in which case the original pages are marked as deleted (c-i and g-i) and the newly written pages receive the addresses corresponding to the original c and g pages. The latter is done by accordingly updating the pointers and translation lookaside buffers in the controller to reflect the entire file location which is a mixture between old and updated data.

Alternatively or in addition, the controller catalogues all deleted files and, as soon as a matching data pattern is transferred by the host to the device, it picks the matching data patterns as destination and “un-deletes” the data by redirecting the appropriate pointers to the data location. In another embodiment, a similar strategy is pursued, though the logical to physical address translation unit has the capability of having several pointers directed to the same physical data structure. For example, in the case of audiovisual content, including still images, large areas of images could be white or black, in which case a single data location could be used to store the pixel values which are then included into several image files. In other words, the image files share data amongst them.

While certain components are shown and preferred for NAND flash-based solid state drives of this invention, it is foreseeable that functionally-equivalent components could be used or subsequently developed to perform the intended functions of the disclosed components. For example, different storage media as they develop with similar operational characteristics could be used as replacement of NAND flash memory device. Therefore, while the invention has been described in terms of a preferred embodiment, it is apparent that other forms could be adopted by one skilled in the art, and the scope of the invention is to be limited only by the following claims.

1. A solid state drive adapted for use with a host system, the solid state drive comprising:
at least one non-volatile memory device comprising pages that are organized into memory blocks, the pages being sequentially programmable and readable, the memory blocks being minimum-erasable units of the memory device; and
a controller configured to perform direct data comparison between stored data of existing files stored within the non-volatile memory device and subsequent data of an incoming data stream being written by the host system to the solid state drive.

2. The solid state drive of claim 1, wherein the non-volatile memory device is a NAND flash-based memory device and the data comparison is done on a sector basis.

3. A method of operating a solid state drive connected to a host system so as to receive an incoming data stream containing data written by the host system to the solid state drive, the solid state drive comprising a controller and at least one non-volatile memory device comprising pages that are organized into memory blocks, the pages being sequentially programmable and readable, the memory blocks being minimum-erasable units of the memory device, the method comprising:
storing data of the incoming data stream on the non-volatile memory device to define stored data of existing files within the memory blocks of the non-volatile memory device, at least some of the existing files defining valid files that are within some of the memory blocks that contain valid data; and
operating the controller to perform direct data comparison between the stored data of the existing files and subsequent data of the incoming data stream.

4. The method of claim 3, wherein the non-volatile memory device is a NAND flash-based memory device and the data comparison is done on a sector basis.

5. The method of claim 4, wherein the controller finds a sector content of the subsequent data that is identical to a sector content of a deleted file, and the sector content of the subsequent data is not written to the non-volatile memory device but the file translation layer is updated to point to the existing sector.

6. The method of claim 5, further comprising finding a matching sector within one of the memory blocks containing the invalid data that matches a sector of the subsequent data of the incoming data stream, the matching sector is undeleted, and data of the sector of the subsequent data are not written to the non-volatile memory device.

7. The method of claim 6, wherein the controller preferentially checks the existing files against incoming files of the subsequent data of the incoming data stream for an incoming file having the same file name as one of the existing files, and the controller preferentially checks the existing files and the incoming files with the same file name for identical sector content.

8. A method for reducing writes from a host system to a solid state drive that is connected to the host system so as to receive an incoming data stream containing data, the solid state drive comprising a controller and at least one non-volatile memory device comprising pages that are organized into memory blocks, the pages being sequentially programmable and readable, the memory blocks being minimum-erasable units of the memory device, the method comprising:
comparing the data of the incoming data stream to existing data stored within memory blocks of the non-volatile memory device;
writing the data of the incoming data stream to the non-volatile memory device if no match is found between the data of the incoming data stream and the existing data; and
discarding the data of the incoming data stream if a matching data pattern for an existing sector is found between the data of the incoming data stream and the existing data, and updating the file translation layer to point to the existing sector.

9. The method of claim 8, wherein the matching data pattern of the existing sector is part of at least one deleted file within memory blocks of the non-volatile memory device.

10. The method of claim 8, wherein the existing sector is linked to several logical addresses.

11. The method of claim 10, wherein a plurality of repetitive data sectors within one file are stored in one physical sector on the media, the sector being associated with a plurality of addresses.

12. The method of claim 10 wherein a plurality of data sectors belonging to different files are stored in one physical sector on the media, the sector being associated with a plurality of addresses.
